(19) United States
(12) Patent Application Publication
(10) Pub. No.: US 2014/0052661 A1
(43) Pub. Date: Feb. 20, 2014

(54) CUSTOMER CENTRIC PICKUP LOCATIONS

(71) Applicants: Jonathan J. Shakes, Mercer Island, WA (US); Qi Zou, Shanghai (CN)

(72) Inventors: Jonathan J. Shakes, Mercer Island, WA (US); Qi Zou, Shanghai (CN)

(21) Appl. No.: 13/589,557

(22) Filed: Aug. 20, 2012

(51) Int. Cl. G06Q 10/08

(52) U.S. Cl. CPC G06Q 10/0836
USPC 705/339

(57) ABSTRACT

A temporary pickup location that is located within a delivery area during a predefined timeframe provides an opportunity to customers to retrieve orders for items at a time and location that is convenient for them. In addition, the customers can pay for the items at retrieval (COD) and avoid the bulk and waste of shipping packages. In some implementations, temporary pickup locations are made available by planning to position a delivery agent and transportation unit at a predefined location during a predefined timeframe during which customers can plan to retrieve ordered items.

### BACKGROUND

Many companies package items and/or groups of items together for a variety of purposes, such as e-commerce and mail-order companies that package items (e.g., books, CDs, apparel, food, etc.) to be shipped to fulfill orders from users. Retailers, wholesalers, and other product distributors (which may collectively be referred to as distributors) typically maintain an inventory of various items that may be ordered by clients or users. This inventory may be maintained and processed at a materials handling facility which may include, but is not limited to, one or more of: warehouses, distribution centers, cross-docking facilities, order fulfillment facilities, packaging facilities, shipping facilities, or other facilities or combinations of facilities for performing one or more functions of material (inventory) handling.

Typically ordered items are packed in shipping packages (e.g., corrugated boxes) and shipped to the user's residence or place of business. Some shipments require that the customer be present to sign for the items, or pay for the items upon delivery (e.g., Cash On Delivery—COD) or to receive items that are too large to fit in fixed-size mailboxes. This requires that the customer, or another individual, either remain at the delivery location on the planned day of delivery or arrange a specific timeframe during which the package will be delivered and the customer will be there to receive the package.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a broad view of the operation of a materials handling facility, in one implementation.

FIGS. 2-3 depict example graphical user interfaces for selecting a temporary pickup location or a delivery area.

FIG. 4 depicts a block diagram of temporary pickup location planning system, in one implementation.

FIG. 5 depicts a block diagram of temporary pickup locations at various delivery areas, in one implementation.

FIG. 6 is a flow diagram illustrating an example process for utilizing temporary pickup locations to provide items to customers.

FIG. 7 is a flow diagram illustrating an example process for planning temporary pickup locations.

FIG. 8 is a flow diagram illustrating an example process for delivering an item to a customer.

FIG. 9 is a block diagram illustrating an example computer system configured to implement one or more of the systems or processes described herein.

While implementations are described herein by way of example, those skilled in the art will recognize that the implementations are not limited to the examples or drawings described. It should be understood that the drawings and detailed description thereto are not intended to limit implementations to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

This disclosure describes, in part, an environment that includes the planning and offering of temporary pickup locations at times and locations that are convenient to customers. Generally described, a temporary pickup location is a physical location at which an agent, carrier or other individual is located for a predefined timeframe (also referred to herein as a predefined time period) to allow for customers to retrieve ordered items. In some instances, the temporary pickup location may simply be a street corner at which the agent parks his transportation unit (e.g., bike, truck, cart, dolly, backpack) for a predefined timeframe and makes items available for retrieval by customers. For example, a customer may order an item via an e-commerce website, select a delivery timeframe of Friday and select a temporary pickup location that is available on Friday evening from 5:00 PM-7:30 PM at a location near a subway exit the customer uses on their way home from work. The ordered item may be picked from a materials handling facility, transported by an agent in a transportation unit to the temporary pickup location prior to, at the beginning of or during the designated delivery timeframe and made available for retrieval by the customer that evening on their way home from work. The temporary pickup location may not include any permanent or physical structure; just the agent, the transportation unit and the items to be delivered to customers. In other implementations, the temporary pickup location may utilize existing structures, such as a freeway overpass, a lobby in a building, a lobby of a public facility, and the like. In some implementations, the transportation unit may include identifiers (e.g., lights, flags, signage, branding) to help customers identify the temporary pickup location. The agent will be available at the temporary pickup location to allow the customer to retrieve the item, sign and/or pay for the item.

Not only does this environment reduce the need for customers to be present at the delivery location until the item is delivered (e.g., to sign and/or pay for the item), temporary pickup locations may also be used by individuals to ship and/or return items. For example, a merchant may sell an item on an e-commerce website, pack the item in a shipping box and deliver the packed item to the agent at a temporary pickup location for shipping. At the temporary pickup location, the merchant can pay the agent for shipping costs, receive tracking information, etc. Likewise, a customer may use the temporary pickup location to return items. For example, a customer may bring an item to be returned to a temporary pickup location, initiate the return process, receive tracking information and return the item. Alternatively, the customer could initiate the return process on the e-commerce website, or through another user interface, obtain the necessary return information and provide the item to the temporary pickup location for return.

In still another implementation, items delivered to customers using temporary pickup locations may be fulfilled without packing the items in a shipping package. For example, rather than packing an ordered item in a shipping package at a materials handling facility to protect it from damage during shipping, the item may be picked directly into a delivery container (e.g., tote, bin), the delivery container transported to the temporary pickup location and the item made available to the customer. In such an implementation, the delivery container may include items ordered by multiple customers that will retrieve the items at the temporary pickup location. In some implementations, prior to placing the items in the delivery container, the items may be placed into bags. The bags provide added security and privacy for the customers without the added bulk, weight and materials cost of a shipping package.

In another example, temporary pickup locations may be used to store and deliver high-volume and/or release day items or to enable customers to pay for items (e.g., digital content, or ordered but not yet delivered items). A high-volume item may be, for example, an item that is frequently ordered, such as a popular book, shoe, video game, etc. A release day item may be an item that will become available on the day it is released to the general public (e.g., book, movie, game, toy). For high-volume and/or release day items, the items may be immediately available to customers or available for pickup on the release day. As discussed further below, high-volume items may be transported to various temporary pickup locations and made available to customers at those temporary pickup locations for immediate pickup during the predefined timeframe during which the temporary pickup location is available. Similarly, release day items may be transported to various temporary pickup locations on the release day and made available for immediate pickup during the predefined timeframe during which the temporary pickup location is available.

In another example, customers may also visit a temporary pickup location to pay for digital content, pay for credits to use in purchasing digital content or to pay for ordered items. For example, some customers may prefer to pay cash for items. Those customers may pay in cash to an agent at the temporary pickup location and have credits applied to a digital account that can be used to purchase digital content (e.g., movies, music, games) or obtain the digital content directly from the temporary pickup location.

In yet another example, a temporary pickup location may be used as an alternative pickup location for items that were originally planned for attended or unattended delivery to a customer specified location. For example, if an agent was unable to deliver an item requiring customer signature (attended delivery), the agent may hold the item and make it available at a temporary pickup location. In such an example, rather than leaving a message that a delivery was attempted, the customer may receive a message that delivery was attempted, re-delivery will be attempted the next day, or the customer may retrieve the item from the temporary pickup location during the predefined time period at which the temporary pickup location will be available. In this example, or in other instances where an order was originally planned for attended or unattended delivery (e.g., doorstep delivery at a customer's home), the customer may modify the delivery destination to be a temporary pickup location.

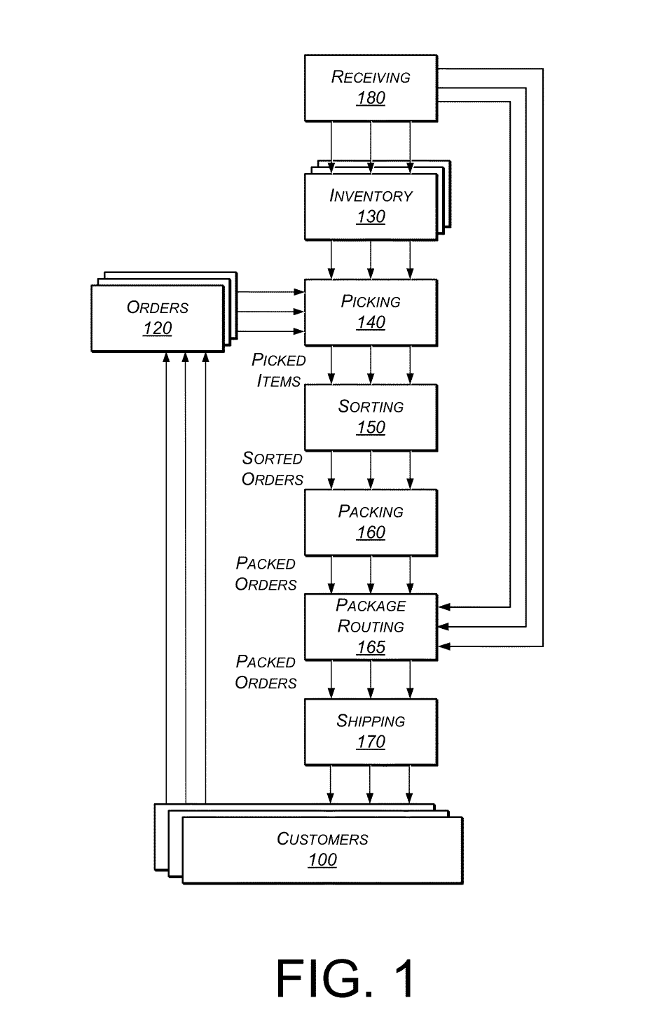

A block diagram of a materials handling facility, which, in one implementation, may be an order fulfillment facility configured to utilize various systems and processes described herein, is illustrated in FIG. 1. In this example, multiple customers 100 may submit orders 120, where each order 120 specifies one or more items from inventory 130 to be shipped to the customer or to another entity specified in the order. An order fulfillment facility typically includes a receiving operation 180 for receiving shipments of stock from various vendors and storing the received stock in inventory 130. To fulfill the orders 120, the item(s) specified in each order may be retrieved or “picked” from inventory 130 (which may also be referred to as stock storage) in the order fulfillment facility, as indicated by picking operation 140. In some implementations, the items of a customer order may be divided into multiple shipment sets for fulfillment by an order planning system before fulfillment instructions are generated (not shown). As used herein, the term “shipment set” may refer to a single item of a customer's order, multiple items of a customer's order, or all items of a customer's order.

In some instances, when a customer has selected a temporary pickup location as the delivery destination, the item(s) of one or more shipment sets may be picked at the picking operation 140 directly into delivery containers. A “delivery container,” as used herein, may be any form of container used in transporting or handling items. For example, a delivery container may be a tote, pallet, bin, trailer, etc. Additionally, the delivery container may be segmented or otherwise include division points, permanent or movable, that enable separation of items within the delivery container. In some instances, items themselves, such as larger items (e.g., big screen televisions, desks, cabinets) may be considered and treated as delivery containers. The delivery container may also include a unique identifier, such as a bar code, QR code, unique number, etc. to enable tracking and identification of the delivery container and association of items placed in the delivery container. For example, during a picking operation, an agent within the materials handling facility may scan the bar code of the delivery container and scan a barcode or identifier of the picked item as the item is placed into the delivery container. Scanning of the delivery container and the picked item results in the item becoming associated with and tracked with the delivery container. In some implementations, for delivery containers that are segmented or otherwise include division points, those segments may each include a unique identifier (e.g., bar code). As items are placed in the delivery container segments, they may be associated with a specific location, or segment within the delivery container by scanning the identifier of that segment.

Regardless of whether the items are picked directly into delivery containers or to be packed in shipping packages, after picking the items may be delivered to one or more stations in the order fulfillment facility for sorting 150 into their respective shipment sets and for packing 160 in shipping packages. Because items may not be packed in shipping packages, for security and/or privacy reasons they may be placed into bags, such as a solid black bag. The packing slip may also be included in the bag or applied to the item (e.g., stickered to the item), printed out at a temporary pickup location upon retrieval of the item by the customer, or otherwise made available to a customer.

In some implementations, items received at receiving 180 may not be stock inventory and may be processed and delivered to the package routing operation 165 for shipping 170 to customer 100. For example, receiving 180 may receive an item from a merchant that is to be delivered to a customer 100. In another example, receiving may receive items from another materials handling facility or another vendor destined for a customer 100.

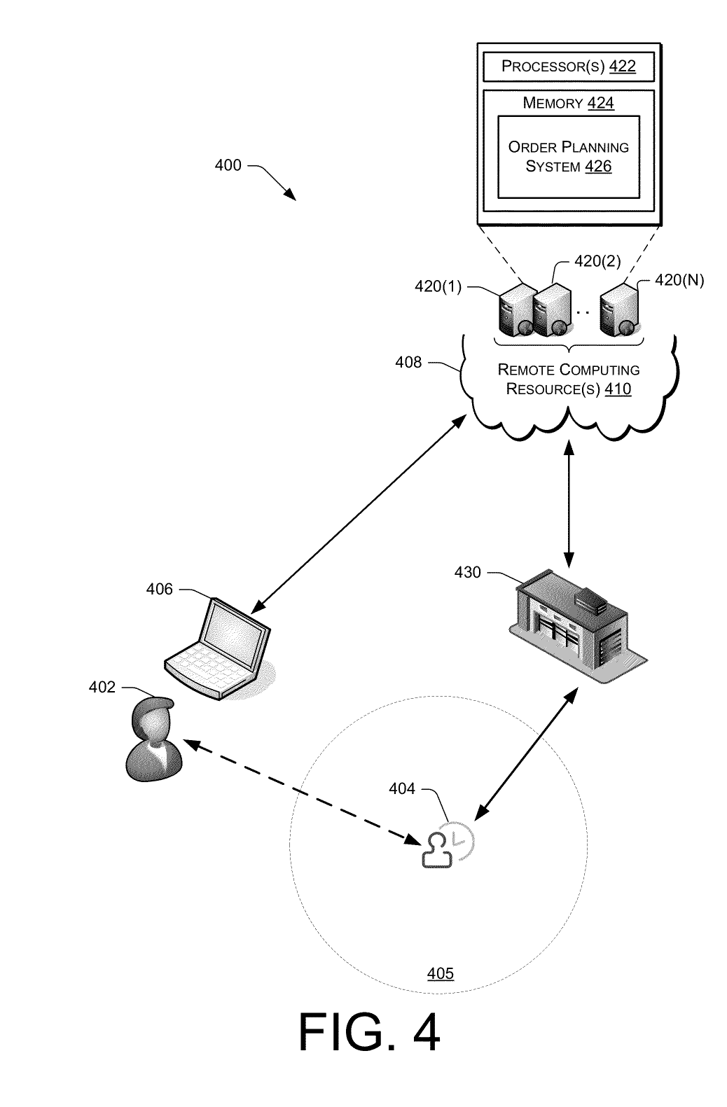

A package routing operation 165 may sort orders for routing to one of two or more shipping operations 170, from which they may be shipped to the customers 100 or routed to a distribution location for transport to a temporary pickup location for retrieval by the customers 100. The package routing operation 165 may in various implementations be automated or manual. The package routing operation 165 may receive an indication of the destination to which each packed shipment set should be routed from a central control system or order planning system (FIG. 4).

In some implementations, the routing operation may route the picked or sorted items to a particular packing station 160 depending upon the size or type of the shipping package into which the items are to be packaged. For example, not all shipping packages utilized in the facility may be available at all of the packing stations 160. Similarly, some packing stations 160 may not have access to protective materials recommended for shipping fragile items or items for which additional protection may be appropriate. Therefore, if an item (or at least one item in a group of items to be shipped together) requires special packaging, a routing operation may be configured to direct the item(s) to a packing station 160 at which an appropriate shipping package and/or protective materials are available. Likewise, if a fragile item is designated for picking into a delivery container or transfer container, it may be routed to a packing station (not shown) at which appropriate protective material or packaging is available to allow for proper handling of the item(s).

Note that not every fulfillment facility may include both sorting and packing stations. In certain implementations, agents may transfer picked items directly to a packing station, such as packing station 160, while in other implementations, agents may transfer picked items to a combination of sorting and packing stations (not illustrated). This may result in a stream and/or batches of picked items for multiple incomplete or complete shipment sets being delivered to a sorting station for sorting 150 into their respective shipment sets for packing and shipping, according to one implementation.

Portions of a shipment set may be received at different times or during different time intervals. When portions of a shipment set do not arrive during the same time interval, sorting 150 and packing 160 may have to wait for one or more items of some shipment sets to be delivered to the sorting station(s) before processing of the shipment set can be completed. Note that a picked, packed and shipped shipment set does not necessarily include all of the items ordered by the customer; a shipped shipment set may include only a subset of the ordered items available to ship at one time from one materials handling facility. Also note that the various operations of a materials handling facility may be located in one building or facility, or alternatively may be spread or subdivided across two or more buildings or facilities.

The arrangement and order of operations illustrated by FIG. 1 is merely one example of many possible implementations of the operation of a materials handling facility, such as an order fulfillment facility, that enables transport of items to temporary pickup locations for retrieval by customers. Other types of materials handling, manufacturing, or order fulfillment facilities may include different, fewer, or additional operations and resources, according to different implementations.

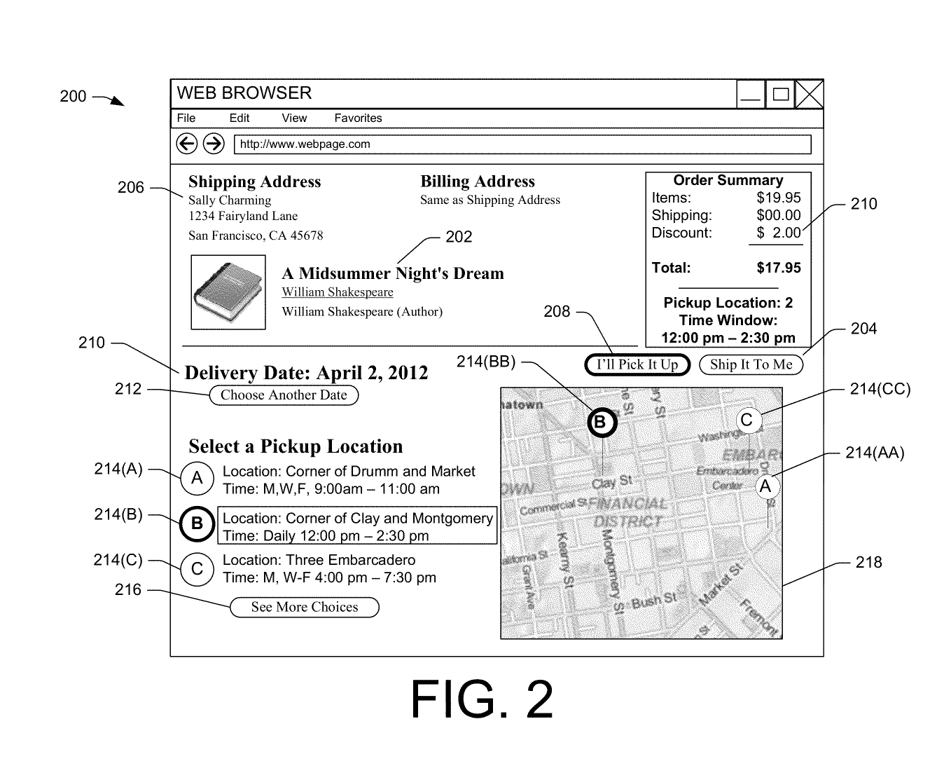

FIG. 2 depicts a graphical user interface 200 for purchasing an item and selecting a temporary pickup location, in one implementation. In this example the user has requested to purchase a book entitled “A Midsummer Night's Dream” 202. As part of the purchase process, the customer may select to have the item delivered to the customer (e.g., attended or unattended delivery) or select a temporary pickup location at which the customer can retrieve the item. For example, the user may select the “Ship it to me” button 204 and provide a shipping address 206 to which the item is to be delivered. Attended delivery, as used herein, is delivery to a customer specified location (e.g., residence or business address) at a prearranged time when the customer or other individual will meet the delivery person to receive delivery of the item. Attended delivery includes, but is not limited to a scheduled delivery, COD, items that require signature for delivery (e.g., alcohol), or if there is no secure location at which to leave the item. Unattended delivery, as used herein, is delivery of an item to customer specific location (e.g., residence or business address) where the item may be left unattended, such as on the customers front porch or in an apartment mailroom.

Alternatively, the customer may select the “I'll pick it up” button 208 and select a temporary pickup location at which the customer may retrieve the item. In some implementations, the customer may receive a discount or other incentive to utilize the option of retrieving the item from a temporary pickup location.

As part of the purchase process, the order planning system 426 may identify a delivery timeframe 210 indicating the day or days during which the purchased item 202 will be delivered or available for retrieval by the customer. To choose another delivery timeframe, a customer may select the “choose another date” button 212. If they are satisfied with the delivery timeframe 201, the customer may select a temporary pickup location, such as temporary pickup location 214(A), 214(B), 214(C) or select the “See More Choices” button 216 to see additional temporary pickup locations.

A customer may interact with the graphical user interface 200 to select a temporary pickup location by either selecting the description of the pickup location, such as temporary pickup locations 214(A), 214(B), 214(C) or by interacting with a temporary pickup location identifier pin 214(AA), 214(BB), 214(CC) displayed on the map 218. In this example, the user has selected temporary pickup location 214(B), as illustrated by the bold around the temporary pickup location pin 214 (BB) and the box indicator around the pickup location name 214(B).

Temporary pickup locations displayed to a user as part of the purchase process in the graphical user interface 200 may be selected in a variety of manners. For example, a customer may specify preferred temporary pickup locations, a customer may specify preferred delivery areas (as described in more detail below), the order planning system 426 may identify temporary pickup locations based off of prior customer orders and/or distribution locations, the order planning system 426 may identify temporary pickup locations based on a determined or provided location of the customer, or through any other means. The order planning system 426 may identify customer location using a variety of techniques. For example, if the customer is purchasing an item using a mobile device, global positioning satellite information may be provided to the order planning system 426 by the mobile device and used to determine the customer's location. Alternatively, an IP address of the customer's device may be used to notify a delivery area or customer location. In some implementations, a customer may also specify a route, such as a commuter route, along which temporary pickup locations may be identified by the order planning system 426.

Temporary pickup locations may be selected based on both a location, and a predetermined timeframe. For example, if the delivery timeframe 210 is Apr. 2, 2012, temporary pickup locations that are available on Apr. 2, 2012 will be provided as options to the customer via the graphical user interface 200. In some implementations, the graphical user interface 200 may also specify a predetermined timeframe during which the temporary pickup locations will be available. For example, temporary pickup location 214(A) is available on Monday, Wednesday, Friday from 9:00 AM-11:00 AM.

In some implementations, a customer may alternatively create a location for a temporary pickup location. For example, if a planned temporary pickup location is not convenient for the customer, the customer may select on the map a location at which a temporary pickup will be planned. Upon selection, the order planning system may determine to plan a temporary pickup location at the physical location specified by the user and make that temporary location available to other customers for selection.

Upon customer selection of a pickup location, such as a temporary pickup location 214(B), the order planning system may process the customer's order for the delivery prior to, at the beginning of or during the specified delivery timeframe 210 for retrieval by the customer at the selected temporary pickup location 214(B), as described in more detail herein.

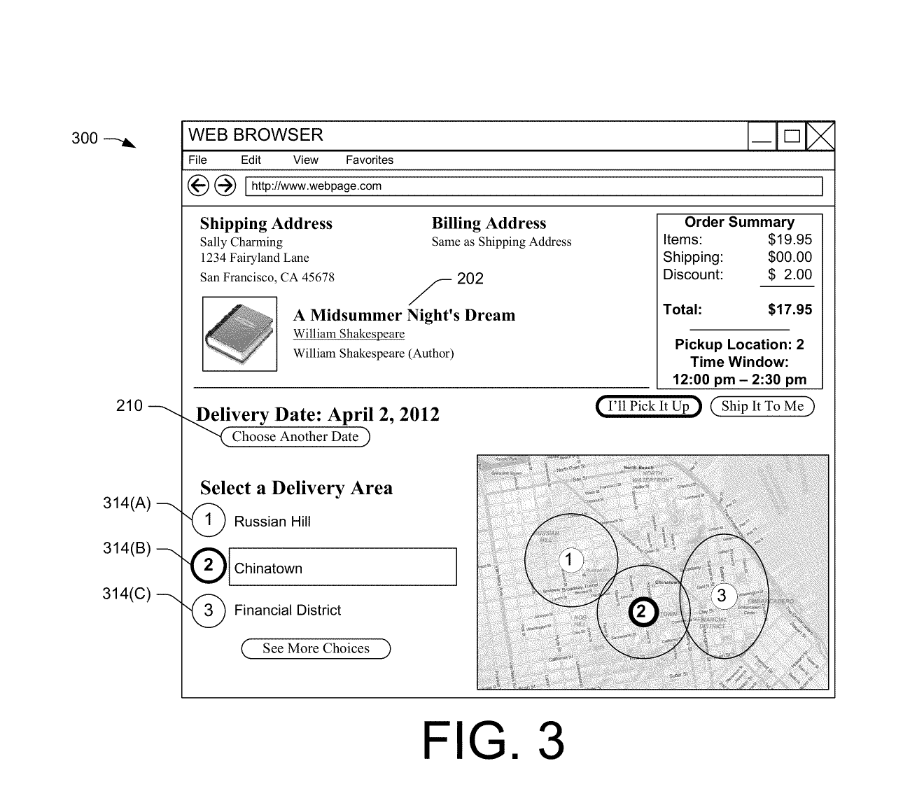

In an alternative implementation, rather than selecting a specific temporary pickup location at the time a customer places an order to purchase an item, as illustrated in FIG. 3, the graphical user interface 200 may allow a user to select a delivery area, such as the delivery area of Russian Hill 314(A), Chinatown 314(B), or the Financial District 314(C). A delivery area may be a geographic area surrounding one or more planned temporary pickup locations. For example, a delivery area may be a two mile radius around a planned temporary pickup location. In an alternative implementation, a delivery area may be a geographic area in which the customer is willing to retrieve the item from a temporary pickup location. Similar to the graphical user interface 200 described with respect to FIG. 2, the graphical user interface 300 illustrated in FIG. 3 may identify delivery areas for which a pickup location will be available during the planned delivery timeframe 210. In this example, rather than providing temporary pickup locations at predefined timeframes, the user may select a desired delivery area. As the delivery timeframe 210 approaches, the customer may receive a subsequent communication from the order planning system 426 allowing the user to select a temporary pickup location within the selected delivery area. For example, if the user selects the delivery area of Chinatown 314(B) at the time of placing the order for the book “A Midsummer Night's Dream” 202 with a planned delivery timeframe 210 of Apr. 2, 2012, the order planning system 426 may process the customer's order and initiate transport of the ordered item 200 to the distribution location that services the selected delivery area of Chinatown 314(B). As the delivery timeframe approaches, the customer may receive a subsequent communication identifying the temporary pickup locations and times of availability of the temporary pickup locations that will be available within the selected delivery area during the planned delivery timeframe. The customer may then select a preferred temporary pickup location within the delivery area for retrieval of the ordered item.

FIG. 4 is a block diagram of an illustrative temporary pickup location ordering environment 400 that enables a customer 402 to select a temporary pickup location 404 for retrieval of an ordered item. The temporary pickup location ordering environment 400 includes a user interface, such as a graphical user interface 200 (FIG. 2) or 300 (FIG. 3) that allows a customer 402 to place an order for purchase of an item that will be retrieved by the customer from a temporary pickup location 404. The user interface may be a graphical user interface, such as graphical user interface 200, 300, an audio only interface, a multi-mode interface, or any other interface for interacting with the customer 402. The user interface may be provided to the customer 402 through any type of electronic device 406, such as a tablet, desktop, laptop, smart phone, personal digital assistant, netbook, etc. The user interface may be delivered to the electronic device 406 by one or more remote computing resources 410 that make up part or all of an electronic commerce shopping environment. In other embodiments, the user interface may be direct communication between a customer and an agent.

The remote computing resources 410 may form a portion of a network-accessible computing platform implemented as a computing infrastructure of processors, storage, software, data access, and other components that is maintained and accessible via a network 408. Services, such as e-commerce shopping services, offered by the remote computing resources 410 do not require the customer have knowledge of the physical location and configuration of the system that delivers the services. The electronic device 406 may communicatively couple to the remote computing resources 110 via the network 108 which may represent wired technologies (e.g., wires, USB, fiber optic cable, etc.), wireless technologies (e.g., RF, cellular, satellite, Bluetooth, etc.), and/or other connection technologies. The network 408 carries data between the electronic device and the remote computing resources 410.

After receiving from a customer 402 a request to purchase an item and selection of a temporary pickup location, the electronic device may send this information to the remote computing resources 410 over the network 408. As illustrated, the remote computing resources 410 may include one or more servers, such as servers 420(1), 420(2), . . . , 420(N). These servers 420(1)-(N) may be arranged in any number of ways, such as server farms, stacks, and the like that are commonly used in data centers. Furthermore, the servers 420(1)-(N) may include one or more processors 422 and memory 424 which may store an order planning system 426.

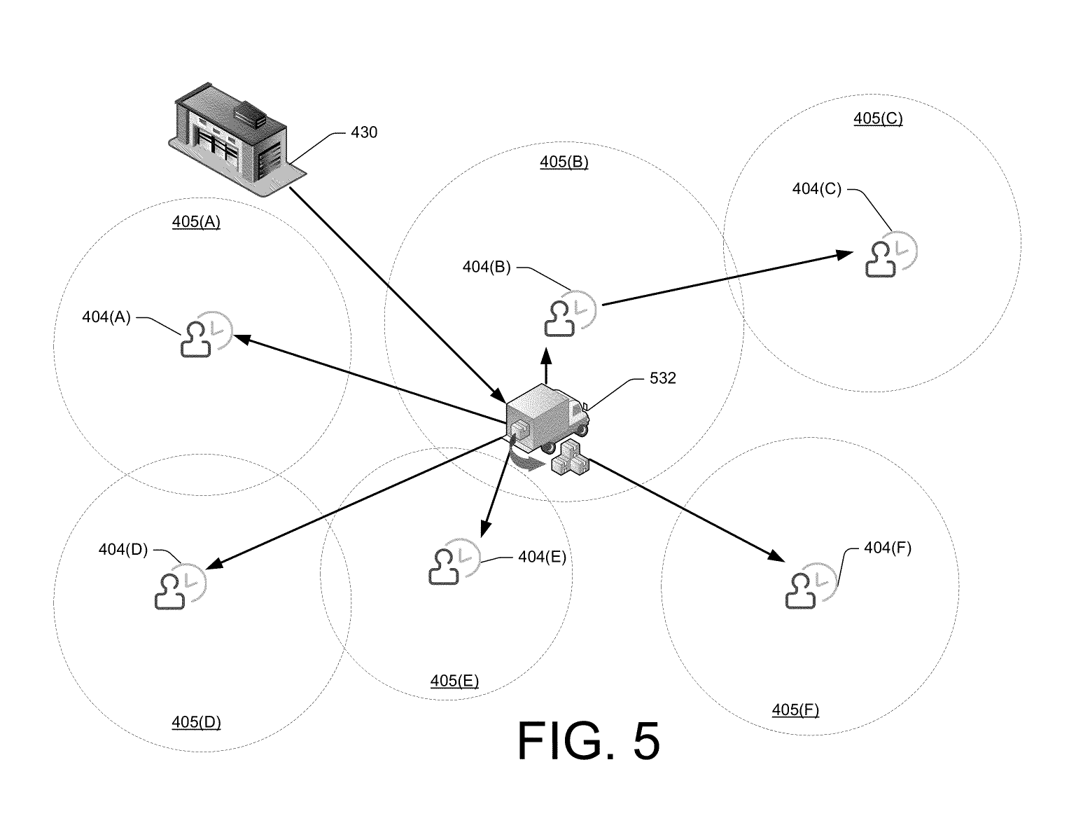

The order planning system 426 may be configured, for example, to perform order planning and schedule delivery of orders to various temporary pickup locations or other customer specified delivery locations. In some instances, the order planning system 426 may separate an order into shipment sets and instruct one or more materials handling systems 430 to fulfill the shipment sets to the customer specified location or to a customer selected temporary pickup location 404 for retrieval by the customer. In fulfilling orders to a temporary pickup location, the materials handling facility 430 may fulfill orders using any of the processes discussed above with respect to FIG. 1 and an agent may transport the items to a planned location and make the temporary pickup location 404 available during a predefined timeframe for customer retrieval of ordered items. In other implementations, the materials handling facility 430 may deliver the items to a distribution location 532 (FIG. 5) that services the temporary pickup location 404, and optionally other temporary pickup locations within the same delivery area. An agent may then retrieve items scheduled for pickup at the temporary pickup location 404 from the distribution location 532, transport those items to the physical spot of the planned temporary pickup location 404 and make those items available for retrieval by customers during the predetermined timeframe for the planned temporary pickup location.

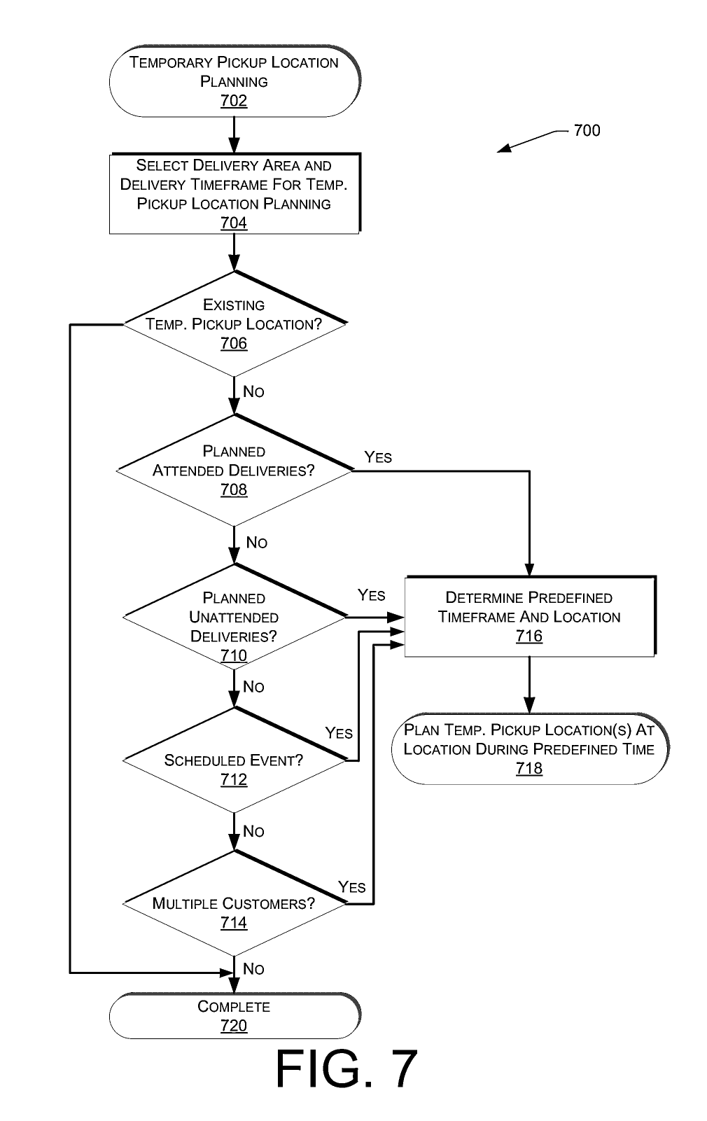

The order planning system 426 may also perform additional planning of temporary pickup locations. For example, as described below with respect to FIG. 7, the order planning system 426 may periodically determine whether to plan a temporary pickup location within a delivery area on particular days/timeframes based on a number of different criteria (e.g., orders planned for delivery, events in the area).

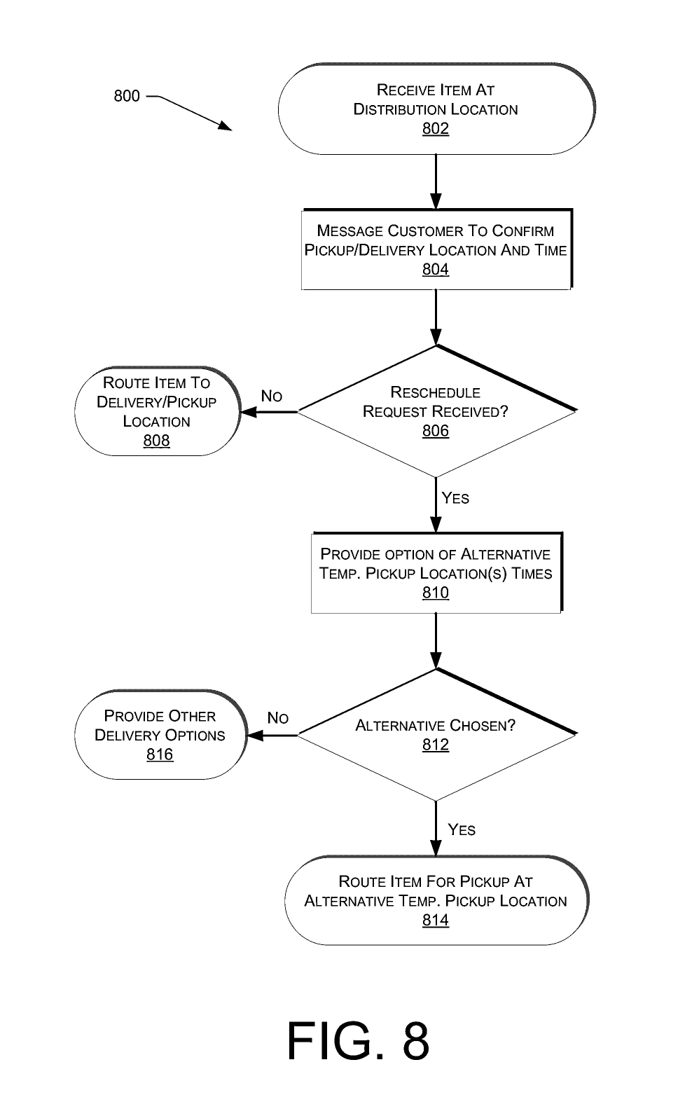

The order planning system 426 may also provide additional communications with the customer 402 and/or agents that will fulfill the customer's order/shipment set. For example, as discussed below with respect to FIG. 8, the order planning system may message the customer before or during the delivery timeframe to confirm the attended delivery or provide temporary pickup locations within a delivery area that the customer can select. In some implementations, the temporary pickup location may be offered as an alternative to a currently planned attended delivery. For example, the customer may receive a discount or other incentive to switch from attended delivery to retrieving the ordered item from a temporary pickup location. In another example, if an item arrives prior to the planned delivery timeframe (e.g., an attended or unattended delivery) the order planning system may notify the customer that the item has arrived early, is available for delivery and provide the option if the customer would like to retrieve the item from a temporary pickup location prior to the currently planned delivery timeframe.

FIG. 5 depicts a block diagram of a group of distributed temporary pickup locations 404(A), 404(B), 404(C), 404(D), 404(E), 404(F) and corresponding delivery areas 405(A), 405(B), 405(C), 405(D), 405(E), 405(F) typically served by each pickup location 404(A)-(F), in one implementation. As described in more detail herein, when an order for one or more items is placed by customer for retrieval at a temporary pickup location, a shipment set for a portion of all of the items in the customer's order will be assigned to a materials handling facility 430 for fulfillment and transport to a distribution location 532 that services the identified temporary pickup location 404(A)-(F). By strategically making temporary pickup locations 404(A)-(F) available during predetermined timeframes at specific locations, a customer may select a temporary pickup location, such as temporary pickup location 404(A) within a geographically convenient delivery area 405(A) at a timeframe that is convenient for the customer. This may be convenient to the customer if they would not be available when the item would otherwise be delivered to the customer selected delivery location (e.g., home), may not want others located at the delivery location to know that they have ordered an item (e.g., a mother may not want a gift for their child delivered to the house) or may not want the item left at an unattended location (e.g., front porch, mailroom) if they are not present when the item is delivered.

When a customer places an order for one or more items, the order planning system 426 may determine if there is a temporary pickup location, such as temporary pickup location 404(A), within a delivery area 405(A) of where the customer may wish to have the items delivered. In some instances, a customer may designate or preselect preferred temporary pickup locations 404(A)-(F), such as pickup location 404(A), or selected preferred delivery areas, such as delivery area 405(A). For example, a customer may designate one temporary pickup location 404(A) as a preferred temporary pickup location along the customer's commute route between the customer's work and home (e.g., at the exit of a subway or bus-stop) and a second delivery area 405(C) near the customer's work, which may include one or more temporary pickup locations 404(C). If an identified temporary pickup location is available, the order planning system 426 may determine if there is available capacity on the transportation unit that will transport the items to the temporary pickup location from the distribution location 532.

For items that have been ordered with a temporary pickup location 404 as the location at which the customer will retrieve the items, the materials handling facility 430 may prepare and ship the shipment set(s) for that order to the distribution location 532 that services those temporary pickup locations. In some implementations, those shipment sets may be transported to the distribution location 532 without packing them into shipping packages. For example, shipment sets assigned to pickup location 404(A) may be picked directly into one or more delivery containers at the materials handling facility 430, transported to the distribution location 532 and loaded onto the transportation unit (e.g., bike, cart, dolly, truck) used to move the items to and become the temporary pickup location 404(A). In other implementations, some of the items loaded onto a transportation unit for transporting the items to the temporary pickup location may be scheduled for delivery directly to a customer within the delivery area. For example, a group of shipment sets may be scheduled for final delivery to homes within the delivery area 405(E). The transportation unit for that delivery area 405(E) may be loaded with items scheduled for retrieval at the temporary pickup location 404(E) as well as items with planned attended delivery or unattended delivery within the delivery area 405(E). Attended delivery items or unattended delivery items may be delivered either before or after the predetermined timeframe planned for the temporary pickup location 404(E) and/or may be retrieved by the customer from the temporary pickup location 404(E) before the planned attended delivery to the customer.

In another example, while a shipment set may be associated with an attended or unattended delivery to the customer (e.g., the customer's home) at a time prior to the attended/unattended delivery, the customer may select to have the shipment set redirected and delivered to a temporary pickup location 404. In such an example, if the shipment set has not yet left the materials handling facility 430, it may be re-designated for shipment to a temporary pickup location 404. This may include a temporary pickup location serviced by that materials handling facility 430 or a temporary pickup location serviced by another materials handling facility that also has the ordered item(s) in stock and available for delivery. If the shipment set is in transit from a materials handling facility 430 to a distribution location 532, it may be re-routed to a temporary pickup location 504(A)-504(F) serviced by the distribution location 532. If it is already loaded onto a transportation unit for attended/unattended delivery to the customer, if that transportation unit will also act as a temporary pickup location 404, the shipment set may be re-designated for retrieval by the customer at the temporary pickup location 404.

In another example, a temporary pickup location 404, such as temporary pickup location 404(B), may also be used to provide items to another transportation unit that then serves as a temporary pickup location 404(C). Alternatively, the same transportation unit may serve as multiple temporary pickup locations, such as temporary pickup location 404(B) and temporary pickup location 404(C). For example, a transportation unit may serve as a temporary pickup location 404(B) from 9:00 AM-11:00 AM and then move to a different delivery area 405(C) and serve as a temporary pickup location 404(C) from 5:00 PM-7:30 PM. Between those two times, the transportation unit may complete attended/unattended deliveries to customers, retrieve items from customers or merchants that are to be shipped and/or return to the distribution location 532 to retrieve additional shipment sets or drop off items that have been picked up or provided by merchants or other customers.

In addition to serving as temporary pickup locations 404(A)-404(F) and delivering shipment sets directly to customers, transportation units may also be used to receive items from customers or merchants and transport those items to the distribution location 532, to other temporary pickup locations 404, or to other destinations. Such items may be picked up directly from customers or the items may be delivered by the customer to a temporary pickup location. For example, if a transportation unit is servings as a temporary pickup location 404(D) from 10:15 AM-3:45 PM, a merchant with an item to be shipped may arrive at the temporary pickup location 404(D) during the predetermined timeframe and provide the item for shipment. Providing the item to the temporary pickup location may also include paying for shipping of the item and/or receiving tracking information for the item.

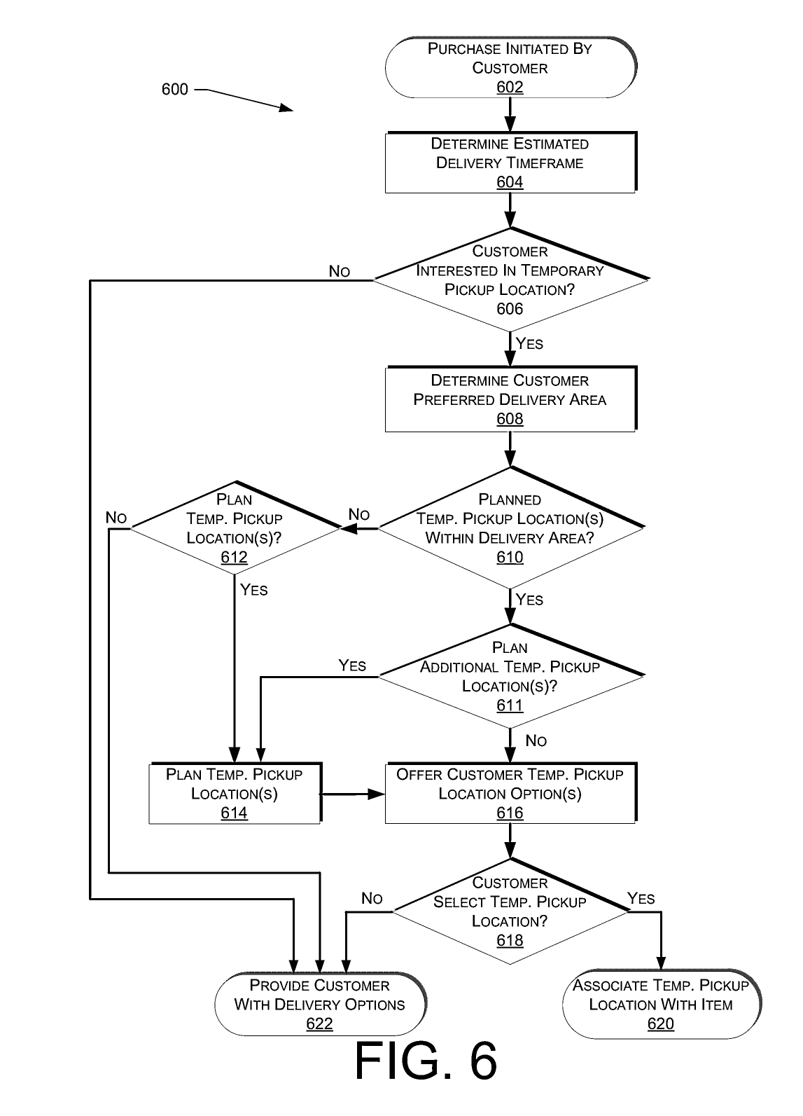

FIG. 6 is a flow diagram illustrating an example process 600 for utilizing temporary pickup locations to provide items to customers. This process, and each process described herein, may be implemented by the architectures described herein or by other architectures. The process is illustrated as a collection of blocks in a logical flow graph. Some of the blocks represent operations that can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded or uploaded through the Internet or other networks. Finally, the order in which the operations are described is not intended to be construed as a limitation, and any number of the described operations can be combined in any order and/or in parallel to implement the process.

The example process 600 begins upon receiving a purchase request initiated by customer, as in 602. Upon receiving a purchase request for an item from a customer, a determination is made as to the estimated delivery timeframe for that item, as in 604. In some examples, this may include identifying a materials handling facility with the requested item in stock and estimating the time required to fulfill the item to the customer. In other implementations, the estimated delivery timeframe may be a set day from the date of the purchase request or a series of days. For example, a customer may specify that the delivery timeframe is to be one day from the date of purchase request or between three and five days from the date of the purchase request. In still other implementations, the estimated delivery timeframe may be a set day of the week upon which the customer has requested to have items delivered. For example, a customer may preselect to have items ordered during the week delivered on Thursday of every week.

In addition to determining an estimated delivery timeframe, a determination is made as whether the customer is interested in retrieving the item from a temporary pickup location, as in 606. Determining whether a customer is interested in retrieving the item from a temporary pickup location may be done, for example, by receiving an interaction from the user through a user interface 200 selecting to pick up the item or otherwise retrieve the item from a temporary pickup location. Alternatively, a customer may preselect or provide a preference that they prefer to retrieve their items from temporary pickup locations.

If it is determined that the customer is interested in retrieving the items from a temporary pickup location, one or more preferred delivery areas for the customer are determined, as in 608. A preferred delivery area may be, for example, a geographic area in which the customer lives, works, or through which the customer frequently travels/commutes. For example, a preferred delivery area may include a portion of the customer's typical commute route to or from work, such as a location near the exit of a subway station. Determining a preferred delivery area may be done by receiving information from the user as to their preferred delivery areas, identifying preferred delivery areas based on a customer's past purchase and delivery history, based on a customer's known or estimated location, and the like. If a preferred delivery area cannot be determined, in some implementations, the process 600 may inquire with the user as to a preferred delivery area. Likewise if multiple preferred delivery areas are identified for a customer, the process 600 may offer a customer a choice of the multiple preferred delivery areas, as discussed above with respect to FIG. 3. In such an implementation, as the delivery timeframe approaches, the customer may be messaged to select a preferred temporary pickup location within the selected delivery area.

Upon determining the customer's preferred delivery area, a determination is made as to whether there are one or more planned temporary pickup locations within the preferred delivery area available during the planned delivery timeframe, as in 610. If it is determined that there are one or more planned temporary pickup locations within the preferred delivery area available during the planned delivery timeframe, the customer may be provided with the option to select the most convenient temporary pickup location, as in 616 and as discussed above with respect to FIG. 2. Temporary pickup locations may be distributed throughout a delivery area and available during different predefined timeframes throughout the delivery timeframe. For example, some temporary pickup locations may only be available in the morning, others in the afternoon, others in the evening, and some available all day. In some implementations, even though there are existing temporary pickup locations within the preferred delivery area available during the planned delivery timeframe, a determination may be made as to whether one or more additional temporary pickup locations should be planned, as in 611. Determining to plan additional temporary pickup locations may be based on, for example, a customer choosing to define a temporary pickup location, based on a determination that the existing temporary pickup locations are reaching capacity, determining that the customer's order would require an additional temporary pickup location to deliver it to the preferred delivery area, and the like. In addition, factors such as those discussed below with respect to FIG. 7 may also be considering in determining whether to plan one or more additional temporary pickup locations. If it is determined that no additional temporary pickup locations should be planned, the example process 600 may proceed to offer the customer temporary pickup locations from which they can choose, as in 616.

If it is determined that there are no planned or sufficient temporary pickup locations within the customers preferred delivery area during the planned delivery timeframe, a determination may be made as to whether one or more temporary pickup locations should be planned for a predefined timeframe during the planned delivery timeframe within the customer selected preferred delivery area, as in 612. The process for determining whether to plan a temporary pickup location(s) is discussed in more detail below with respect to FIG. 7. At a high level, in one example, one or more temporary pickup locations may be planned if there are forecasted to be a sufficient number of orders to be delivered within the delivery area that could be made available for pickup at a temporary pickup location during the delivery timeframe. Alternatively, if there are any attended or unattended deliveries already planned during the selected delivery timeframe within the selected delivery area, one or more temporary pickup locations may be planned since a transportation unit will already be in the area.

If it is determined in 611 or 612 that one or more temporary pickup locations should be planned for a predetermined timeframe within the delivery area during the planned delivery timeframe, the process 600 may specify a timeframe during which each added temporary pickup location will be available (the predetermined timeframe) and select a location(s) within the delivery area for the added temporary pickup location(s). Selecting a timeframe and a location within a delivery area for added temporary pickup location(s) may include several factors. For example, it may be determined whether there are other temporary pickup locations currently planned within the delivery area or during a particular timeframe through which customer orders could otherwise be made available for retrieval. In other implementations, selecting a timeframe and a location may depend on the currently planned attended/unattended delivery times and locations for other orders to be delivered during the delivery timeframe in the delivery area. For example, if there are ten orders to be delivered between 2:00 PM-4:00 PM on a Monday within a delivery area during the planned delivery timeframe, a temporary pickup location may be planned within the delivery area during the delivery timeframe at a location geographically near each of the destinations for the ten attended/unattended delivery orders. The predetermined timeframe for the temporary pickup location may be from 2:00 PM-4:00 PM on Monday so those customers can retrieve their orders. In other implementations, the predetermined timeframe may be before or after the planned delivery times for the ten existing orders. Another factor that may be considered is whether the customer(s) with currently planned attended/unattended delivery orders have previously utilized temporary pickup locations from which to retrieve items.

In another example, a delivery agent may use their transportation unit from 9:00 AM-5:00 PM. From 5:00 PM-9:00 AM the following morning they park the transportation unit in a known location, such as a parking lot of a convenience store and enable a person at the convenience store to access the transportation unit. In such an example, a customer could arrive at the transportation unit while it is located at the known location and retrieve an item with the assistance of the person at the known location that can access the transportation unit.

Upon planning one or more temporary pickup locations, as in 614, or if it is determined that a temporary pickup location within the delivery area is already planned, as in 610, or that one or more additional temporary pickup locations do not need to be planned, as in 611, the customer is allowed to select one of the identified temporary pickup locations planned for the delivery timeframe, as in 616. In other examples, a temporary pickup location may be planned real-time. For example, a customer may select on a map 218 (FIG. 2) a location at which a temporary pickup location should be planned and optionally provide a timeframe during which the pickup location should be available.

Because temporary pickup locations vary by location and time, the user may be provided the option of choosing whether they would like to have their items delivered to a temporary pickup location or delivered to another location (e.g. home, business). Additionally, if there are multiple planned temporary pickup locations within the delivery area during the planned delivery timeframe, the customer may choose the temporary pickup location that is most convenient for them based on the predetermined timeframe and/or planned location. Upon offering the one or more temporary pickup locations to the customer, a determination is made as to whether the customer has selected a temporary pickup location for delivery of the items, as in 618. If the customer has selected a temporary pickup location for delivery of the items, the selected temporary pickup location is associated with the items being purchased by the customer, as in 620.

In another implementation, a customer may select both a temporary pickup location and attended/unattended delivery. For example, a customer may select to have an item made available for retrieval from a temporary pickup location for a predefined timeframe (e.g., three days) and if not retrieved during that timeframe have it delivered to a specific location (e.g., their house). In some implementations, the customer may receive an incentive to retrieve the item, or pay an additional charge if the item is ultimately delivered to the specific location and not retrieved.

If it is determined that the customer is not interested in using a temporary pickup location, as in 606, no planned temporary pickup location is available within the delivery area during the delivery timeframe and determination is made that one should not be planned, as in 612, or if the customer does not select one of the available temporary pickup locations, as in 618, the process 600 provides the customer with other delivery options, as in 622. Other delivery options may include allowing the customer to select an alternative delivery timeframe and/or delivery area, plan an attended delivery of the item to a specific location where the customer will meet with an agent to retrieve the item, schedule an unattended delivery, and the like. If the customer selects an alternative delivery timeframe and/or delivery area, the process 600 may return to decision block 610 and continue. If the customer selects to utilize a delivery option other than the temporary pickup location, other delivery options are provided to the customer, as in 622, and the process 600 completes.

FIG. 7 is a flow diagram illustrating an example process 700 for planning temporary pickup locations. The example process 700 of planning a temporary pickup location may be done periodically, at scheduled time intervals, as part of a customer requesting to purchase an item, or any other time, as in 702. At the outset of the example process 700, a delivery area and delivery timeframe for temporary pickup location planning is selected, as in 704. Upon selecting a delivery area and a delivery timeframe for temporary pickup location planning, a determination is made as to whether there is an existing pickup location currently planned for that delivery area, as in 706. In some implementations, if it is determined that an existing pickup location is currently planned during the delivery timeframe for the delivery area, the process 700 may complete, as in 720. In other implementations, identifying a planned temporary pickup location during the selected delivery timeframe within the selected delivery area may be used as a factor in deciding whether to plan an additional temporary pickup location within the delivery area during the delivery timeframe. For example, determining whether there is an existing temporary pickup location may be used as part of the decision process described below with respect to any one of one or more of decision blocks 708, 710, 712, 714 in deciding whether to plan additional temporary pickup locations.

In still another example, if it is determined that there is already a planned temporary pickup location during the selected delivery timeframe in the selected delivery area, the process may determine whether that temporary pickup location is reaching capacity. Because temporary locations may be limited by the transportation unit as to the number of shipment sets it can carry, the delivery area may require multiple temporary pickup locations to enable customers to retrieve orders.

Included in the example process 700 for planning temporary pickup locations, a determination may be made as to whether there are any currently planned attended deliveries within the selected delivery area during the selected delivery timeframe, as in 708. As discussed above, an attended delivery may exist for an already ordered item that is to be delivered directly to a customer during a predetermined timeframe during which the customer will meet the delivery agent to receive the item. This may include paying for the item (cash on delivery), signing for the item, and the like. If it is determined that there is a planned attended delivery, the process 700 may select as a location for the temporary pickup location an area near the planned attended delivery location because the transportation unit will already be at that location. Similarly, the predefined timeframe may be scheduled to occur either before or after the currently planned attended delivery. For example, if an attended delivery is planned to occur in a large apartment complex, a temporary pickup location may be planned to occur at or near that large apartment complex either before or after the timeframe of the planned attended delivery.

If it is determined that there are no planned attended deliveries within the delivery area during the delivery timeframe, a determination is made as to whether there are any planned unattended deliveries scheduled for delivery during the selected delivery timeframe within the selected delivery area, as in 710. If there are planned unattended deliveries scheduled for delivery during the selected delivery timeframe within the selected delivery area, a temporary pickup location may be planned, as discussed below with respect to block 716, to make those items available for retrieval at the temporary pickup location. In addition, other customers may utilize the temporary pickup location for retrieval of items.

If it is determined that there are no planned unattended deliveries, a determination is made as to whether there are any events scheduled to occur within the delivery area during the selected delivery timeframe, as in 712. A scheduled event may be any type of gathering or planned occurrence, such as a concert, sporting event, protest, show, etc. that may attract a large number of customers. In such instances, a temporary pickup location may be used not only to allow customers within the area to retrieve items they have previously ordered but also to retrieve items that may be ordered during or following the scheduled event. For example, if the planned event is a sporting event between two teams, souvenirs associated with those teams may be transported to a temporary pickup location located just outside the sporting event (e.g., in the parking lot) and made available for immediate retrieval by customers during or after the sporting event. In such an implementation, advertising for the souvenirs may be provided during the sporting event with the information that the items may be retrieved from the planned temporary pickup location.

Finally, if it is determined that there are no planned events within the selected delivery area during the selected delivery timeframe, a determination is made as to whether multiple customers will be within the selected delivery area that may otherwise justify planning a temporary pickup location, as in 714. For example, even though there may not be orders or events currently planned for the selected delivery area during the selected delivery timeframe, the selected delivery area may be a high traffic area such as a business district or commuter location. In such locations, customers may frequently commute to and from home, work and/or other locations and may be interested in retrieving ordered items along their commute route rather than having to coordinate for a attended delivery or use an unattended delivery.

Upon an affirmative determination in any of decision blocks 708, 710, 712, 714 the example process 700 determines a delivery timeframe (predefined timeframe) and location within the selected delivery area at which the temporary pickup location will be made available, as in 716. For example, as noted above, if it is determined at decision block 708 that there is a planned attended delivery within the delivery area during the selected delivery timeframe, the process 700 may determine a location of the temporary pickup location to be near the planned attended delivery at a predefined timeframe either before or after the planned attended delivery. Likewise, if it is determined at decision block 710 that there are planned unattended deliveries, the process 700 may select as a location for the temporary pickup location an area near a majority of the planned unattended deliveries such that the customers may choose to retrieve the items from the temporary pickup location rather than having the items left unattended at the currently planned delivery location. It will be appreciated, that an affirmative response to any one of blocks 706, 708, 710, 712, 714 may result in the planning of multiple temporary pickup locations.

Determining selected delivery timeframe(s) (predefined timeframe) and location(s) within a selected delivery area at which temporary pickup location(s) will be made available may consider a variety of factors. For example, a delivery timeframe may be determined by considering the delivery timeframes for other temporary pickup locations within the delivery area, determining customer commute times, or times when customers are in the area, determining event schedules, and the like. Location(s) may also be determined by considering a variety of factors. For example, potential planned locations may be determined based on customer behavior (e.g., commute patters, or other high densities), based on where certain physical structures are located (e.g., public areas, apartment buildings, subway stations, bus stops) and the like. Alternatively, or in addition thereto, factors such as an areas crime rate, population, population density, distance from street corners, parks, street lights, etc. may be considered. In some implementations, potential locations may be further reviewed before a location is planned for a temporary pickup location by analyzing existing images of the area (e.g., satellite images), by physically inspecting the area, and the like.

If it is determined at decision block 714 that the delivery area may have multiple customers during the selected delivery timeframe, one or more temporary pickup locations may be planned and a location selected at high traffic areas within the delivery area at high traffic times. For example, a temporary pickup location may be planned for just outside of a large office complex between 11:30 AM and 1:30 PM Monday-Friday as there are often numerous customers in that area during the lunch hours. One or more additional temporary pickup locations may also be planned for just outside or within a subway station during commute hours.

Upon determining a predefined timeframe(s) and location(s) within the delivery area during the selected delivery timeframe for the one or more temporary pickup location(s), the temporary pickup location(s) is planned and included in future options for customers to select, as in 718. In some implementations a delivery discount or other type of incentive maybe also offered to encourage customers to utilize the temporary pickup locations. If it is determined that there are no affirmative responses in decision blocks 706, 708, 710, 712, 714, the process completes, as in 720.

FIG. 8 is a flow diagram illustrating an example process 800 for delivering an item to a customer. The example process 800 of delivering items to a customer begins upon receipt of an item at a distribution location, as in 802. Upon receiving an item in a distribution location, a message may be sent to the customer to confirm the planned pickup and delivery location and time for an attended delivery or scheduled pickup, as in 804. For example, if a customer has ordered an item and selected attended delivery to occur between 12:00 PM-2:00 PM on Wednesday, when the item is received at the distribution location (e.g., on Tuesday afternoon or Wednesday morning) the customer may receive a phone call or a text message requesting confirmation that they will be available to meet for the planned attended delivery. Likewise if the customer is a merchant with an item to be shipped, before arrival to retrieve the item during a planned scheduled pickup, the merchant may be contacted to confirm that they will be available to meet for the scheduled retrieval. Attended delivery, unattended delivery and scheduled pickup are generally referred to herein as a “planned exchange.”

If no response is received or if the customer confirms availability, as in 806, the item may be routed to the planned location for the attended delivery or scheduled pickup as in 808. However, if a reschedule request is received from a customer, as in 806, options of alternative temporary pickup locations may be provided to the customer as in 810. This may include alternative temporary pickup locations services by the same distribution location at which the items are currently located. In addition, the notification of alternative temporary pickup locations may also include timeframes when those locations will be available. In other implementations the alternative temporary pickup locations may be at other geographic areas identified by customer or at locations where the customer has previously retrieved or had orders delivered/retrieved. Alternative pickup locations may be identified and provided using the techniques discussed above. For example, alternate pickup locations may be provided to the customer through use of an electronic device and a graphical user interface, an audio-based interface, described during a verbal conversation with the customer, and the like.

Upon providing options of alternative temporary pickup locations to the customer, a determination is made as to whether one of those alternative temporary pickup locations has been chosen by the customer, as in 812. A customer may select an alternative temporary pickup location using the same interface through which the alternatives were provided or through any other means of communicating with the order planning system. If it is determined that an alternative temporary pickup location has been chosen by the customer, the item may be routed to the selected temporary pickup location, as in 814. However, if an alternative temporary pickup location has not been chosen, other delivery options may be provided to the customer, as in 816. Other delivery options may include selecting an alternative delivery timeframe, selecting an alternative delivery area, or selecting a different delivery method. For example, a customer may select an alternative delivery timeframe during which they will retrieve an item from a temporary pickup location within a different delivery area or may select an alternative delivery timeframe for another attended delivery or scheduled pickup.

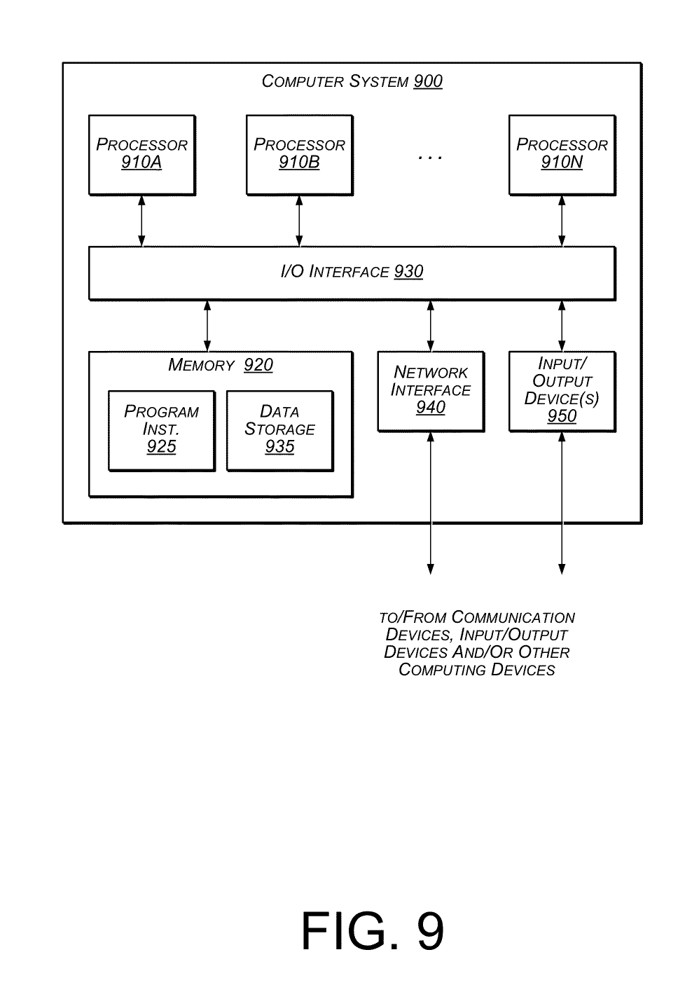

FIG. 9 is a block diagram illustrating an example computer system configured to implement one or more of the operations or processes described herein. In one example the block diagram may be illustrative of one or more aspects of the remote computing resource(s) 410 (FIG. 4) discussed above.

In the illustrated implementation, a computer system 900 includes one or more processors 910A, 910B through 910N, coupled to a non-transitory computer readable storage medium 920 via an input/output (I/O) interface 930. The computer system 900 further includes a network interface 940 coupled to an I/O interface 930, and one or more input/output devices 950. In some implementations, it is contemplated that components of a temporary pickup location environment (e.g., order planning system, user interface, distribution location, materials handling facility, temporary pickup location) may be implemented using a single instance of the computer system 900, while in other implementations, multiple such systems or multiple nodes making up the computer system 900 may be configured to host different portions, components or instances of the temporary pickup location environment. For example, in one implementation, some data sources or services (e.g., order planning) may be implemented via one or more nodes of the computer system 900 that are distinct from those nodes implementing other data sources or services (e.g., fulfillment, customer messaging). In some implementations, a given node may implement the functionality of more than one component of the temporary pickup location environment.

In various implementations, the computer system 900 may be a uniprocessor system including one processor 910A, or a multiprocessor system including several processors 910A-910N (e.g., two, four, eight, or another suitable number). The processors 910A-910N may be any suitable processor capable of executing instructions. For example, in various implementations the processors 910A-910N may be general-purpose or embedded processors implementing any of a variety of instruction set architectures (ISAs), such as the x86, PowerPC, SPARC, or MIPS ISAs, or any other suitable ISA. In multiprocessor systems, each of the processors 910A-910N may commonly, but not necessarily, implement the same ISA.

The non-transitory computer readable storage medium 920 may be configured to store executable instructions and/or data accessible by the one or more processors 910A-910N. In various implementations, the non-transitory computer readable storage medium 920 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions, such as those described above, are shown stored within the non-transitory computer readable storage medium 920 as program instructions 925 and data storage 935, respectively. In other implementations, program instructions and/or data may be received, sent or stored upon different types of computer-accessible media, such as non-transitory media, or on similar media separate from the non-transitory computer readable storage medium 920 or the computer system 900. Generally speaking, a non-transitory, computer readable storage medium may include storage media or memory media such as magnetic or optical media, e.g., disk or CD/DVD-ROM coupled to the computer system 900 via the I/O interface 930. Program instructions and data stored via a non-transitory computer readable medium may be transmitted by transmission media or signals such as electrical, electromagnetic, or digital signals, which may be conveyed via a communication medium such as a network and/or a wireless link, such as may be implemented via the network interface 940.

In one implementation, the I/O interface 930 may be configured to coordinate I/O traffic between the processors 910A-910N, the non-transitory computer readable storage medium 920, and any peripheral devices, the network interface 940 or other peripheral interfaces, such as input/output devices 950. In some implementations, the I/O interface 930 may perform any necessary protocol, timing or other data transformations to convert data signals from one component (e.g., non-transitory computer readable storage medium 920) into a format suitable for use by another component (e.g., processors 910A-910N). In some implementations, the I/O interface 930 may include support for devices attached through various types of peripheral buses, such as a variant of the Peripheral Component Interconnect (PCI) bus standard or the Universal Serial Bus (USB) standard, for example. In some implementations, the function of the I/O interface 930 may be split into two or more separate components, such as a north bridge and a south bridge, for example. Also, in some implementations, some or all of the functionality of the I/O interface 930, such as an interface to the non-transitory computer readable storage medium 920, may be incorporated directly into the processors 910A-910N.

The network interface 940 may be configured to allow data to be exchanged between the computer system 900 and other devices attached to a network, such as other computer systems like the electronic device 406, or between nodes of the computer system 900. For example, the network interface 940 may utilize wireless communication to allow interaction and interface between the electronic device 406 that provides the graphical user interface 200 to a customer and the remote computing resources 410. Likewise, the network interface 940 may enable wired or wireless communication between the remote computing resources 410 and one or more materials handling facilities 430 and/or communication with agents at the temporary pickup locations 404. In various implementations, the network interface 940 may support communication via wired or wireless general data networks, such as any suitable type of Ethernet network. For example, the network interface 940 may support communication via telecommunications/telephony networks such as analog voice networks or digital fiber communications networks, via storage area networks such as Fibre Channel SANs, or via any other suitable type of network and/or protocol.

Input/output devices 950 may, in some implementations, include one or more display terminals, keyboards, keypads, touchpads or any type of electronic device 406 configured to operate within the temporary pickup location environment or communicating with one or more computer systems 900. In some implementations, similar input/output devices may be separate from the computer system 900 and may interact with one or more nodes of the computer system 900 through a wired or wireless connection, such as over the network interface 940.

As shown in FIG. 9, the memory 920 may include program instructions 925 which may be configured to implement aspects of the temporary pickup location environment and data storage 935, which may comprise various tables, databases and/or other data structures accessible by the program instructions 925. In one implementation, the program instructions 925 may include various software modules configured to implement a user interface 200, and order planning system or planning of the temporary pickup locations. The data storage 935 may include various data stores for maintaining information for one or more planned temporary pickup location, data representing the associated delivery area, location for the temporary pickup location, the predefined timeframe for the planned temporary pickup location and/or the items that will be available for retrieval at the planned temporary pickup location.

In various implementations, the parameter values and other data illustrated herein as being included in one or more data stores may be combined with other information not described or may be partitioned differently into more, fewer, or different data structures. In some implementations, data stores used in a pickup location, or in components or portions thereof, may be physically located in one memory or may be distributed among two or more memories. These memories may be part of a single computer system or they may be distributed among two or more computer systems, such as two computer systems connected by a wired or wireless local area network, or through the Internet, in different implementations.

Those skilled in the art will appreciate that the computing system 900 is merely illustrative and is not intended to limit the scope of the present disclosure. In particular, the computing system and devices may include any combination of hardware or software that can perform the indicated functions, including computers, network devices, internet appliances, PDAs, wireless phones, pagers, etc. The computing system 900 may also be connected to other devices that are not illustrated, or instead may operate as a stand-alone system. In addition, the functionality provided by the illustrated components may in some implementations be combined in fewer components or distributed in additional components. Similarly, in some implementations the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated computing system via inter-computer communication. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various implementations may further include receiving, sending or storing instructions and/or data implemented in accordance with the foregoing description upon a computer-accessible medium. Accordingly, the techniques described herein may be practiced with other computer system configurations.

Those skilled in the art will appreciate that in some implementations the functionality provided by the processes and systems discussed above may be provided in alternative ways, such as being split among more software modules or routines or consolidated into fewer modules or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a computer readable storage medium, other aspects may likewise be so embodied. Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A method comprising:
under control of one or more computing devices configured with executable instructions,
receiving from a customer a request for an item;
determining a customer preferred delivery area;
determining at least one delivery timeframe;
identifying at least one temporary pickup location planned for the at least one delivery timeframe and located within the customer preferred delivery area from which the customer may retrieve the item, wherein at least one of the at least one temporary pickup location is planned based at least in part on a planned exchange of a second item during the at least one delivery timeframe and located within the customer preferred delivery area, and where the at least one temporary pickup location is within the customer preferred delivery area during a predefined timeframe at a predefined location; and
for each of the at least one temporary pickup locations, notifying the customer of the predefined location of the temporary pickup location and the predefined timeframe during which the item may be retrieved from the temporary pickup location during the delivery timeframe.

2. A method as recited in claim 1, wherein identifying at least one temporary pickup location includes planning a temporary pickup location at a predefined timeframe, at a predefined location within the customer preferred delivery area.

3. A method as recited in claim 2, wherein planning a temporary pickup location is based at least in part on the customer's request to purchase an item and at least one other customer request to purchase an item.

4. A method as recited in claim 2, wherein planning a temporary pickup location is based at least in part on an item to be delivered within the customer preferred delivery area.

5. A method as recited in claim 1, wherein the planned exchange of a second item is an attended delivery of an item within the customer preferred delivery area.

6. A method as recited in claim 5, wherein the attended delivery of an item includes delivering the item to a location other than the temporary pickup location.

7. One or more computer readable media storing computer-executable instructions that, when executed on one or more processors, cause the one or more processors to perform acts comprising:
messaging a customer to confirm delivery of an item to a location during a first predefined timeframe;
identifying a temporary pickup location at which the item may be retrieved during a second predefined timeframe; and
notifying the customer of a location of the temporary pickup location and a second predefined timeframe during which the item may be retrieved from the temporary pickup location.

8. One or more computer readable media as recited in claim 7, wherein the second predefined timeframe is prior to the first predefined timeframe.

9. One or more computer readable media as recited in claim 7, the acts further comprising:
routing the item to the temporary pickup location for retrieval by the customer during the second predefined timeframe.

10. One or more computer readable media as recited in claim 7, wherein identifying a temporary pickup location at which the item may be retrieved is in response to receiving a request from the customer to reschedule delivery of the item.

11. One or more computer readable media as recited in claim 7, wherein the location is within a customer preferred delivery area and the temporary pickup location is planned for a second location within the customer preferred delivery area.

12. One or more computer readable media as recited in claim 7, wherein the location for delivery is a location of the customer and the temporary pickup location is a planned location from which the customer may retrieve the item.

13. One or more computer readable media as recited in claim 7, wherein the location for delivery is a first temporary pickup location within a first customer preferred delivery area and the temporary pickup location is distinct from the first temporary pickup location but within the customer preferred delivery area.

14. One or more computer readable media as recited in claim 7, wherein a location and predefined timeframe planned for a temporary pickup location is based at least in part on a customer density around the location during the predefined timeframe.

15. One or more computer readable media as recited in claim 7, wherein a location and predefined timeframe planned for a temporary pickup location is based at least in part on an event scheduled near the location.

16. One or more computer readable media as recited in claim 7, wherein a location planned for a temporary pickup location is based at least in part on an order density around the location.

17. A non-transitory computer readable storage medium storing instructions for temporary pickup location planning, the instructions when executed by a processor causing the processor to:
identify a delivery area and a delivery timeframe for temporary pickup location planning;
determine if there is a planned attended delivery within the delivery area during the delivery timeframe; and
in response to a determination that there is a planned attended delivery within the delivery area during the delivery timeframe, plan a temporary pickup location at a location within the delivery area for a predefined timeframe during the delivery timeframe.

18. The non-transitory computer readable storage medium of claim 17, wherein the predefined timeframe is for a period of time prior to a time for the planned attended delivery.

19. The non-transitory computer readable storage medium of claim 17, the instructions when executed by the processor further causing the processor to:
determine if there is a plurality of orders scheduled for delivery within the delivery area during the delivery timeframe; and
in response to a determination that there is plurality of orders scheduled for delivery within the area during the delivery timeframe, plan a temporary pickup location at a location within the delivery area for a predefined timeframe during the delivery timeframe.

20. The non-transitory computer readable storage medium of claim 19, wherein at least a portion of the plurality of orders may be retrieved from the planned temporary pickup location during the predefined timeframe.

21. The non-transitory computer readable storage medium of claim 17, the instructions when executed by the processor further causing the processor to:
determine if there is a plurality of customers within the delivery area during the delivery timeframe; and
in response to a determination that there is a plurality of customers within the delivery area during the delivery timeframe, plan a temporary pickup location at a location within the delivery area for a predefined timeframe during the delivery timeframe.

22. The non-transitory computer readable storage medium of claim 17, the instructions when executed by the processor further causing the processor to:
determine if there is a planned event within the delivery area during the delivery timeframe; and
in response to a determination that there is a planned event within the delivery area during the delivery timeframe, plan a temporary pickup location at a location within the delivery area for a predefined timeframe during the delivery timeframe.
